(19) United States
(12) Patent Application Publication
(10) Pub. No.: US 2003/0006643 A1
(43) Pub. Date: Jan. 9, 2003

(54) Bicycle wheel with two-section spokes

(76) Inventor: Chao-Ying Chen, Tainan Hsien (TW)

Correspondence Address: CHRISTIE, PARKER & HALE, LLP, 350 WEST COLORADO BOULEVARD, SUITE 500, PASADENA, CA, 91105, US

(21) Appl. No.: 09/898,594

(22) Filed: Jul. 3, 2001

(51) Int. Cl. B60B 9/26

(52) U.S. Cl. 301/104

(57) ABSTRACT

A bicycle wheel has a hub, an annular wheel rim surrounding the hub, and a plurality of spokes that interconnect the hub and the wheel rim. Each of the spokes includes first and second spoke sections and a coupling seat. The first spoke section has a connecting end portion connected to the hub, and an opposite threaded end portion. The second spoke section has a connecting end portion connected to the wheel rim, and an opposite threaded end portion. The coupling seat is formed with first and second coupling sockets for connecting threadedly and respectively with the threaded end portions of the first and second spoke sections.

### BACKGROUND OF THE INVENTION

1. Field of the Invention

The invention relates to a bicycle wheel, more particularly to a bicycle wheel having two-section spokes.

2. Description of the Related Art

Referring to FIG. 1, a conventional bicycle wheel 1 is shown to comprise a hub 11, an annular wheel rim 12 that surrounds the hub 11, a plurality of spokes 13 that interconnect the hub 11 and the wheel rim 12, a tire 14 mounted on the wheel rim 12, and a plurality of fasteners 15 for retaining the spokes 13 on the wheel rim 12. The spokes 13 position the hub 11 at the center of the wheel rim 12 and cooperate to impart rigidity to the bicycle wheel 1.

The wheel rim 12 includes an annular rim body 121 with a U-shaped cross-section, and an annular bridging wall 122 interconnecting lateral wall portions of the rim body 121. The rim body 121 and the bridging wall 122 cooperate to confine an annular compartment 123. The rim body 121 has a base wall portion formed with a plurality of mounting holes 124 that correspond in number with the spokes 13. The bridging wall 122 is formed with a plurality of access holes 125 that are registered with the mounting holes 124, respectively. Each of the spokes 13 has a hook end portion 131 and a threaded end portion 132. Each of the fasteners 15 has a head portion 151 and an internally threaded socket portion 152.

During assembly, each of the fasteners 15 is extended into the compartment 123 via the access holes 125 such that the head portion 151 thereof abuts against the base wall portion of the rim body 121, and such that the socket portion 152 thereof extends through a respective one of the mounting holes 124. After engaging the hook end portion 131 of each of the spokes 13 with the hub 11, the threaded end portion 132 of each of the spokes 13 is threadedly engaged within the socket portion 152 of a respective one of the fasteners 15. The spokes 13 connect the hub 11 and the wheel rim 12 under tension at this time.

The following are some of the drawbacks of the aforesaid conventional bicycle wheel 1:

1. The bridging wall 122 of the wheel rim 12 has to be formed with the access holes 125 so that the fasteners 15 can be extended into the compartment 123. The presence of the access holes 125 weakens the structural strength of the bridging wall 122 and thus the overall structural strength of the wheel rim 12.

2. The fasteners 15 are liable to loosen from the spokes 13 due to friction forces acting between the fasteners 15 and the wheel rim 12 when the conventional bicycle wheel 1 is in use, thereby affecting adversely the safety of the bicycle wheel 1.

3. Due to the presence of the access holes 125 in the wheel rim 12, the tire 14 that can be used in the conventional bicycle wheel 1 is limited to one having an inflatable inner tire body 141, which results in additional expense.

### SUMMARY OF THE INVENTION

Therefore, the main object of the present invention is to provide a bicycle wheel that can overcome the aforesaid drawbacks that are associated with the prior art.

According to the present invention, a bicycle wheel comprises a hub, an annular wheel rim surrounding the hub, and a plurality of spokes that interconnect the hub and the wheel rim. Each of the spokes includes first and second spoke sections and a coupling seat. The first spoke section has a connecting end portion connected to the hub, and an opposite threaded end portion. The second spoke section has a connecting end portion connected to the wheel rim, and an opposite threaded end portion. The coupling seat is formed with first and second coupling sockets for connecting threadedly and respectively with the threaded end portions of the first and second spoke sections.

Preferably, the connecting end portions of the first and second spoke sections are hooked onto the respective one of the hub and the wheel rim.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic partly sectional view of a conventional bicycle wheel;

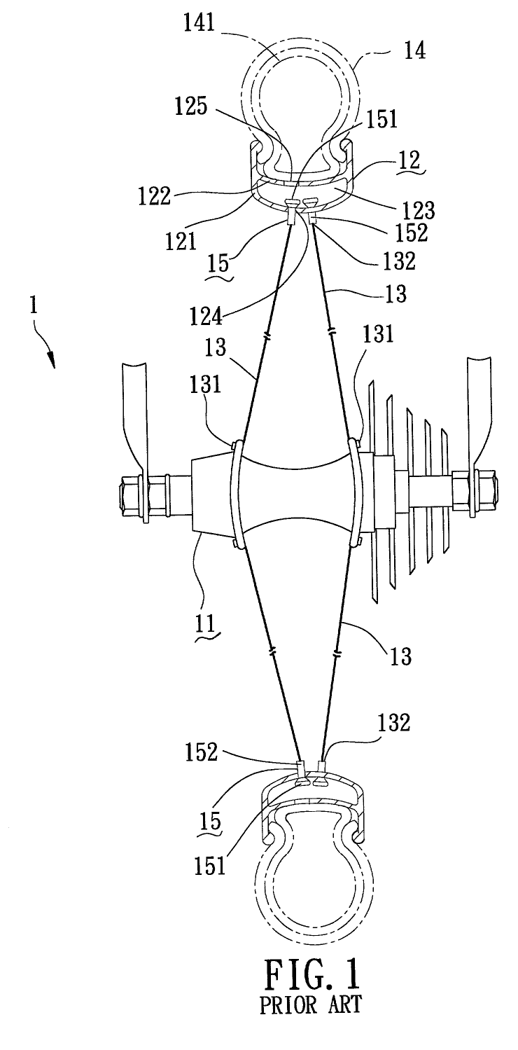

FIG. 2 is a fragmentary schematic partly sectional view of the first preferred embodiment of a bicycle wheel with two-section spokes according to the present invention; and

FIG. 3 is a fragmentary schematic partly sectional view of the second preferred embodiment of a bicycle wheel with two-section spokes according to the present invention.

### DETAILED DESCRIPTION OF THE PREFERRED EMBODIMENTS

Before the present invention is described in greater detail, it should be noted that like elements are denoted by the same reference numerals throughout the disclosure.

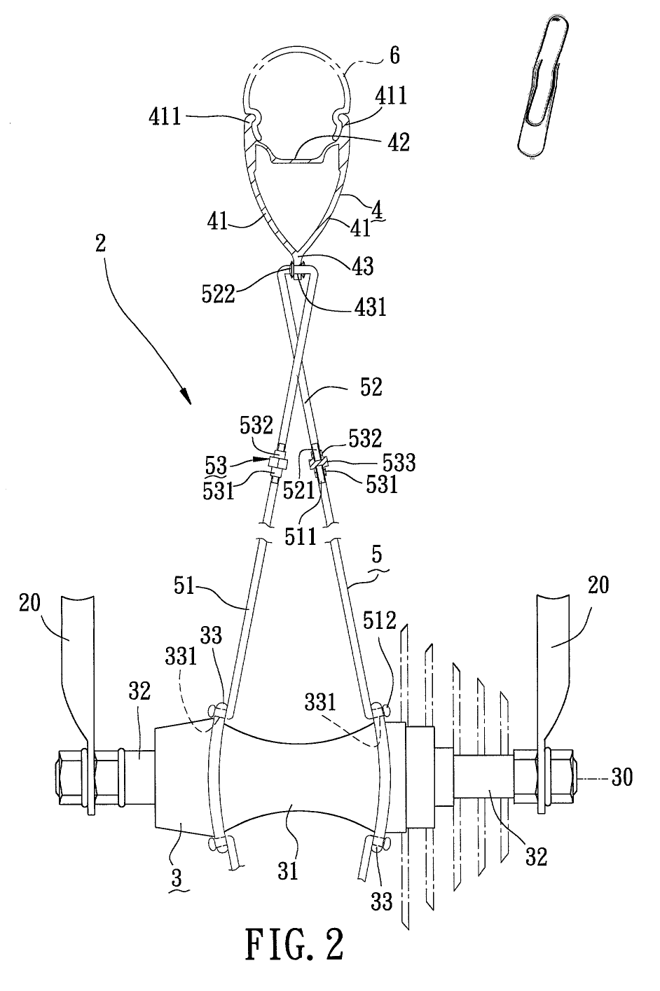

Referring to FIG. 2, the first preferred embodiment of a bicycle wheel 2 according to the present invention is adapted to be mounted on a fork 20 of a bicycle frame and is shown to comprise a hub 3, a wheel rim 4, and a plurality of spokes 5. The wheel rim 4 has a tire 6 mounted thereon.

The hub 3 includes a hub body 31, a pair of frame mounting portions 32 disposed on opposite ends of the hub body 31, and a pair of hub flanges 33 that extend radially and outwardly from the hub body 31. The frame mounting portions 32 are adapted to be mounted securely on the fork 20 of the bicycle frame in a conventional manner. The hub body 31 is rotatable about a hub axis 30. Each of the hub flanges 33 is formed with a plurality of angularly spaced apart first mounting holes 331.

In this embodiment, the wheel rim 4 includes a generally V-shaped rim body that converges in a radial inward direction relative to the hub axis 30 and that has left and right wall portions 41 with interconnected radial inner ends proximate to the hub axis 30 and radial outer ends 411 distal from the hub axis 30. The wheel rim 4 further includes a bridging wall 42 that interconnects the wall portions 41 proximate to the radial outer ends 411, and a spoke connecting flange 43 that extends radially and inwardly from the radial inner ends of the wall portions 41 toward the hub axis 30 and that is formed with a plurality of angularly spaced apart second mounting holes 431 having hole axes that are parallel to the hub axis 30. The tire 6 is retained on the wheel rim 4 by the radial outer ends 411 of the wall portions 41, and cooperates with the wall portions 41 and the bridging wall 42 to confine an inflatable air compartment.

The spokes 5 interconnect the hub 3 and the wheel rim 4. Each of the spokes 5 includes a first spoke section 51 connected to the hub 3, a second spoke section 52 connected to the wheel rim 4, and a coupling seat 53 for interconnecting the first and second spoke sections 51, 52 such that the spoke 5 connects the hub 3 and the wheel rim 4 under tension. The coupling seat 53 includes a first coupling socket 531, a second coupling socket 532 aligned with the first coupling socket 531, and a tool engaging portion 533 formed between the first and second coupling sockets 531, 532. Each of the first and second coupling sockets 531, 532 is formed with an internal screw thread. The internal screw threads of the first and second coupling sockets 531, 532 are oriented in opposite directions, the purpose of which will be described hereinafter. The tool engaging portion 533 has a polygonal surface which is adapted to be engaged by a wrench. The first spoke section 51 of each of the spokes 5 has a threaded end portion 511 for connecting threadedly with the first coupling socket 531 of the coupling seat 53, and an opposite connecting end portion 512 for hooking onto one of the hub flanges 33 at one of the first mounting holes 331. The second spoke section 52 of each of the spokes 5 has a threaded end portion 521 for connecting threadedly with the second coupling socket 532 of the coupling seat 53, and an opposite connecting end portion 522 for hooking onto the spoke connecting flange 43 at one of the second mounting holes 431.

While the connecting end portions 512, 522 of the first and second spoke sections 51, 52 of this embodiment are formed into hooks by bending the spoke sections 51, 52, the particular configuration of the connecting end portions 512, 522 should not be limited thereto.

During assembly, the connecting end portions 512, 522 of the first and second spoke sections 51, 52 of each spoke 5 are connected to one of the hub flanges 33 and the spoke connecting flange 43 at one of the mounting holes 331, 431 in the manner described beforehand. Thereafter, the threaded end portions 511, 521 of the first and second spoke sections 51, 52 are threadedly engaged within the first and second coupling sockets 531, 532 of the coupling seats 53. Because the internal screw threads of the first and second coupling sockets 531, 532 are oriented in opposite directions, when a wrench (not shown) is used to engage the tool engaging portion 533 of each coupling seat 53, the coupling seats 53 can be rotated so that the spokes 5 can connect the hub 3 and the wheel rim 4 under tension, thereby positioning the hub 3 at the center of the wheel rim 4 and thereby imparting rigidity to the bicycle wheel 2.

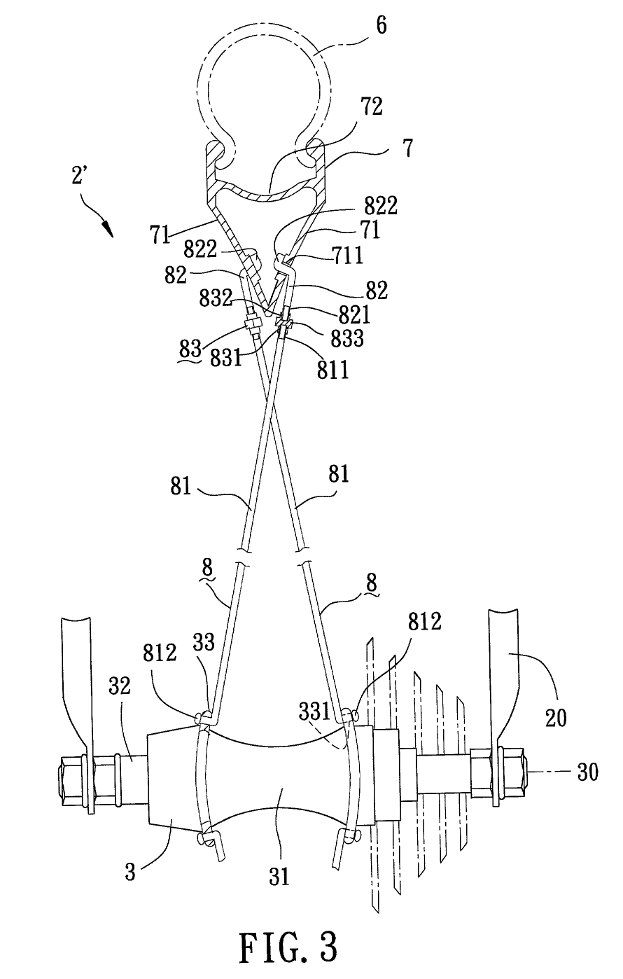

Referring to FIG. 3, the second preferred embodiment of a bicycle wheel 2′ according to the present invention is also adapted to be mounted on a fork 20 of a bicycle frame, and is shown to similarly comprise a hub 3, an annular wheel rim 7, and a plurality of spokes 8. The wheel rim 7 has a tire 6 mounted thereon.

The hub 3 is similar to that of the previous embodiment, and includes a hub body 31 rotatable about a hub axis 30, a pair of frame mounting portions 32 adapted to be mounted on the fork 20, and a pair of hub flanges 33 that extend radially and outwardly from the hub body 31 and that are formed with a plurality of angularly spaced apart first mounting holes 331.

In this embodiment, the wheel rim 7 includes a generally V-shaped rim body that converges in a radial inward direction relative to the hub axis 30 and that has left and right wall portions 71 with interconnected radial inner ends proximate to the hub axis 30 and radial outer ends distal from the hub axis 30. The wheel rim 7 further includes abridging wall 72 that interconnects the wall portions 71 proximate to the radial outer ends of the wall portions 71. Unlike the previous embodiment, each of the wall portions 71 is formed with a plurality of angularly spaced apart second mounting holes 711. Preferably, the second mounting holes 711 in one of the wall portions 71 are staggered relative to the second mounting holes 711 in the other one of the wall portions 71. As with the previous embodiment, the tire 6 is retained on the wheel rim 7 by the radial outer ends of the wall portions 71, and cooperates with the wall portions 71 and the bridging wall 72 to confine an inflatable air compartment.

The spokes 8 interconnect the hub 3 and the wheel rim 7. Each of the spokes 8 includes a first spoke section 81 connected to the hub 3, a second spoke section 82 connected to the wheel rim 7, and a coupling seat 83 for interconnecting the first and second spoke sections 81, 82 such that the spoke 8 connects the hub 3 and the wheel rim 7 under tension. The coupling seat 83 includes a first coupling socket 831, a second coupling socket 832 aligned with the first coupling socket 831, and a tool engaging portion 833 formed between the first and second coupling sockets 831, 832. Each of the first and second coupling sockets 831, 832 is formed with an internal screw thread. The internal screw threads of the first and second coupling sockets 831, 832 are oriented in opposite directions. The tool engaging portion 833 has a polygonal surface which is adapted to be engaged by a wrench.

The first spoke section 81 of each of the spokes 8 has a threaded end portion 811 for connecting threadedly with the first coupling socket 831 of the coupling seat 83, and an opposite connecting end portion 812 for hooking onto one of the hub flanges 33 at one of the first mounting holes 331. The second spoke section 82 of each of the spokes 8 has a threaded end portion 821 for connecting threadedly with the second coupling socket 832 of the coupling seat 83, and an opposite L-shaped connecting end portion 822 that is inserted into one of the second mounting holes 711 for hooking onto one of the wall portions 71. In this embodiment, the connecting end portion 822 has a first segment that is disposed in the respective second mounting hole 711, and a second segment that is generally transverse to the first segment and that abuts against an inner wall surface of one of the wall portions 71, there by resulting in hooking engagement between the second spoke section 82 and said one of the wall portions 71.

During assembly, the connecting end portions 812, 822 of the first and second spoke sections 81, 82 of each spoke 8 are connected to one of the hub flanges 33 and one of the wall portions 71 at one of the mounting holes 331, 711 in the manner described beforehand. Thereafter, the threaded end portions 811, 821 of the first and second spoke sections 81, 82 are threadedly engaged within the first and second coupling sockets 831, 832 of the coupling seats 83. Because the internal screw threads of the first and second coupling sockets 831, 832 are oriented in opposite directions, when a wrench (not shown) is used to engage the tool engaging portion 833 of each coupling seat 83, the coupling seats 83 can be rotated so that the spokes 8 can connect the hub 3 and the wheel rim 7 under tension, thereby positioning the hub 3 at the center of the wheel rim 7 and thereby imparting rigidity to the bicycle wheel 2′.

The following are some of the advantages that can be attributed to the bicycle wheel 2, 2′ of this invention:

Fasteners are not required to establish connection between the second spoke sections of the spokes and the wheel rim. As such, the bridging wall of the wheel rim need not be formed with access holes similar to those in the prior art. Therefore, the overall structural strength of the wheel rim is not weakened, and the tire that can be used in the bicycle wheel of this invention is not limited to one having an inflatable inner tire body. Moreover, the drawback of undesired loosening of the fasteners as encountered in the prior art can be eliminated.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A bicycle wheel comprising a hub, an annular wheel rim surrounding said hub, and a plurality of spokes that interconnect said hub and said wheel rim, wherein each of said spokes includes:
a first spoke section having a connecting end portion connected to said hub, and an opposite threaded end portion;
a second spoke section having a connecting end portion connected to said wheel rim, and an opposite threaded end portion; and
a coupling seat formed with first and second coupling sockets for connecting threadedly and respectively with said threaded end portions of said first and second spoke sections.

2. The bicycle wheel as claimed in claim 1, wherein said wheel rim is formed with a spoke connecting flange that extends radially and inwardly toward said hub and that is formed with a plurality of angularly spaced apart mounting holes, said connecting end portions of said second spoke sections of said spokes being hooked onto said spoke connecting flange at said mounting holes, respectively.

3. The bicycle wheel as claimed in claim 1, wherein said wheel rim has left and right wall portions, each of which is formed with a plurality of angularly spaced apart mounting holes, said connecting end portions of said second spoke sections of said spokes being hooked onto said wall portions of said wheel rim at said mounting holes, respectively.

4. The bicycle wheel as claimed in claim 3, wherein said connecting end portion of said second spoke section is generally L-shaped.

5. The bicycle wheel as claimed in claim 1, wherein said hub is formed with a pair of radial outward hub flanges, each of which is formed with a plurality of angularly spaced apart mounting holes, said connecting end portions of said first spoke sections of said spokes being hooked onto said hub flanges at said mounting holes, respectively.

6. The bicycle wheel as claimed in claim 1, wherein said first and second coupling sockets are aligned with each other, each of said first and second coupling sockets being formed with an internal screw thread, said internal screw threads of said first and second coupling sockets being oriented in opposite directions.

7. The bicycle wheel as claimed in claim 6, wherein said coupling seat further has a tool engaging portion formed between said first and second coupling sockets and having a polygonal surface which is adapted to be engaged by a tool.
